(19) United States
(12) Patent Application Publication
(10) Pub. No.: US 2003/0099086 A1
(43) Pub. Date: May 29, 2003

(54) Foldable keyboard

(76) Inventor: Tsung Jen Chuang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/991,688

(22) Filed: Nov. 26, 2001

(51) Int. Cl. G06F 1/16

(52) U.S. Cl. 361/680

(57) ABSTRACT

A foldable keyboard comprises a keyboard body and a plurality of keys, wherein the keyboard body is composed of at least two touch panels in serial connection and adjacent touch panels are connected by flexible printed circuit such that the touch panels can be stacked each other and expanded. The keys are formed by segmenting a plurality of blocks on the touch panels. A plurality of legends is formed on top surface or bottom surface of the keyboard body.

### FIELD OF THE INVENTION

The present invention relates to a foldable keyboard, especially to a foldable keyboard employing touch panel and applicable to portable electronic devices such as PDA (personal digital assistant) or cellulous phone.

### BACKGROUND OF THE INVENTION

The compact and portable electronic devices such as PDA (personal digital assistant) or cellulous phone are essential for mobile communication era. The compact and portable electronic devices generally uses foldable keyboard for inputting data. The foldable keyboard should be compact for portability while the operational convenience should be preserved.

However, the conventional foldable keyboard for portable electronic devices such as PDA still has a volume larger than PDA itself after the foldable keyboard is folded. More particularly, the conventional foldable keyboard has considerable thickness after the foldable keyboard is folded. It is not convenient for user to put the folded keyboard in his pocket for carry. Moreover, the conventional foldable keyboard has complicated components; the weight and size of the conventional foldable keyboard are hard to be shrunk.

FIGS. 1 and 2 show a conventional foldable keyboard 1a, which comprises two outer panels 10a and 11a, and two inner panels 12a and 13a. The foldable keyboard 1a further comprises a plurality of keys 14a arranged on the two outer panels 10a and 11a, and the two inner panels 12a and 13a. The two inner panels 12a and 13a are pivotally connected and the backsides thereof face to each other when the two inner panels 12a and 13a are collapsed. Moreover, the two outer panels 10a and 11a are pivotally connected to the two inner panels 12a and 13a through respective hinge unit 15a. Therefore, the two outer panels 10a and 11a can be collapsed with respect to the two inner panels 12a and 13a, respectively such that the two inner panels 12a and 13a are sandwiched between the two outer panels 10a and 11a.

The above-mentioned foldable keyboard 1a is segmented to four foldable segments such that the foldable keyboard 1a has only one-fourth area after it is folded. However, the thickness is excessively large and makes the foldable keyboard 1a hard to be put in user's pocket.

Moreover, the key 14a in the above-mentioned foldable keyboard 1a may have scissor structure (not shown) to reduce the thickness of the foldable keyboard 1a after the foldable keyboard 1a is folded. However, the scissor structure is complicated and increases weight of the foldable keyboard 1a.

Alternatively, the spacing between adjacent keys can be decrease to reduce the volume of the folded keyboard. However, the volume reduction is limited and the reduced spacing may increase probability of typing error.

### SUMMARY OF THE INVENTION

It is the first object of the present invention to provide a foldable keyboard employing touch panel, which has compact size and comes in handy.

It is the second object of the present invention to provide a foldable keyboard, which has area same as that of business card after folding and can be expanded to have area same as typing region of a standard keyboard.

To achieve the first object of the present invention, the present invention provides a foldable keyboard comprising a keyboard body and a plurality of keys, wherein the keyboard body is composed of at least two touch panels in serial connection and adjacent touch panels are connected by flexible printed circuit such that the touch panels can be stacked each other and expanded. The keys are formed by segmenting a plurality of blocks on the touch panels.

To achieve the second object of the present invention, the present invention provides a foldable keyboard comprising a keyboard body composed of five touch panels and each of the touch panels has an area same as that of a business card. The foldable keyboard has area same as that of business card after folding.

The various objects and advantages of the present invention will be more readily understood from the following detailed description when read in conjunction with the appended drawing, in which:

### BRIEF DESCRIPTION OF DRAWING

FIG. 1 shows a conventional foldable keyboard in expanding state;

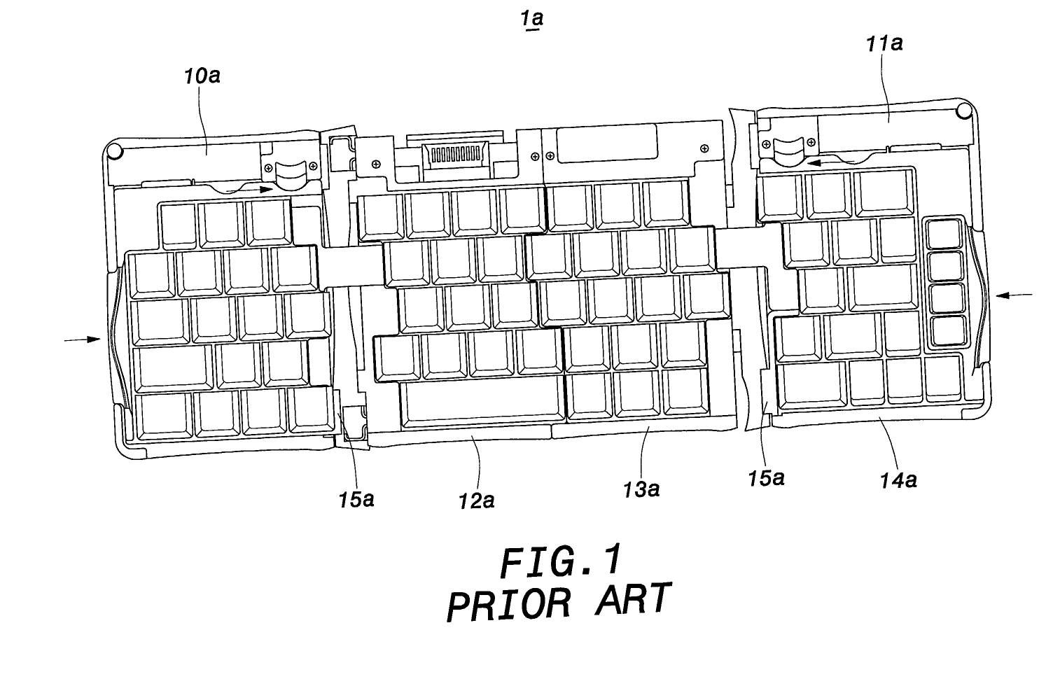

FIG. 2 shows a conventional foldable keyboard in folding state;

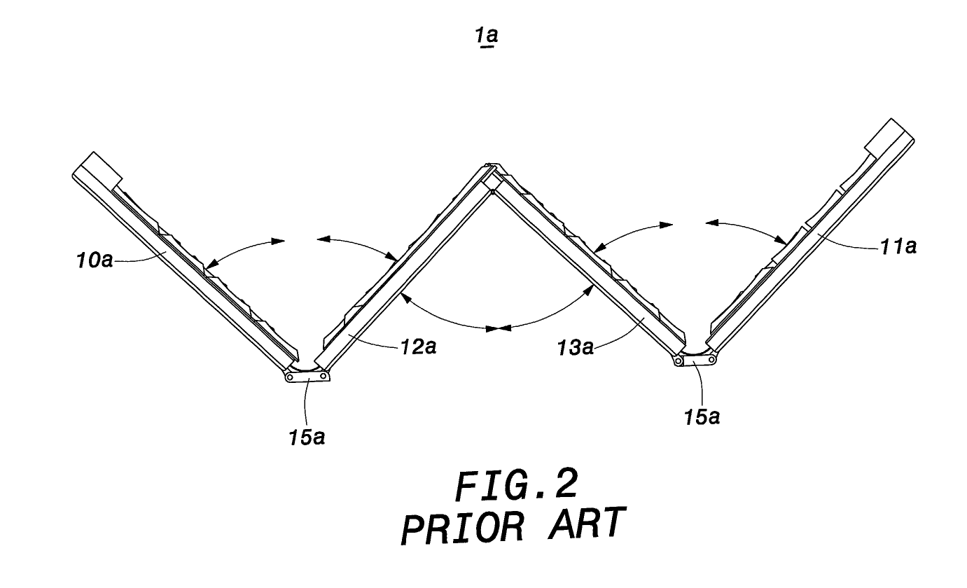

FIG. 3 shows the foldable keyboard of the present invention in expanding state;

FIG. 4 shows the foldable keyboard of the present invention in folding state;

FIG. 5 shows the foldable keyboard of a preferred embodiment of the present invention in expanding state;

FIG. 6 shows the foldable keyboard of a preferred embodiment of the present invention in folding state;

FIG. 7 shows the foldable keyboard of another preferred embodiment of the present invention in expanding state; and

FIG. 8 shows the foldable keyboard of another preferred embodiment of the present invention in folding state.

### DETAILED DESCRIPTION OF THE INVENTION

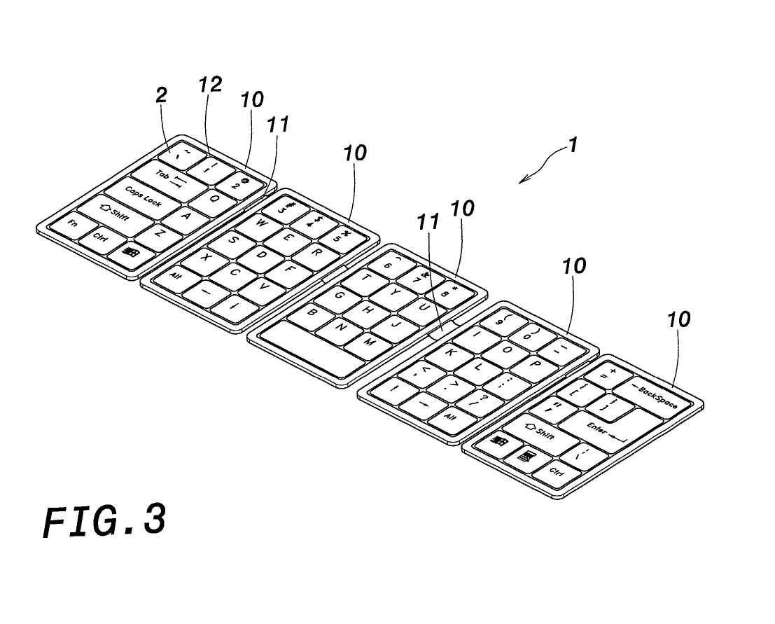

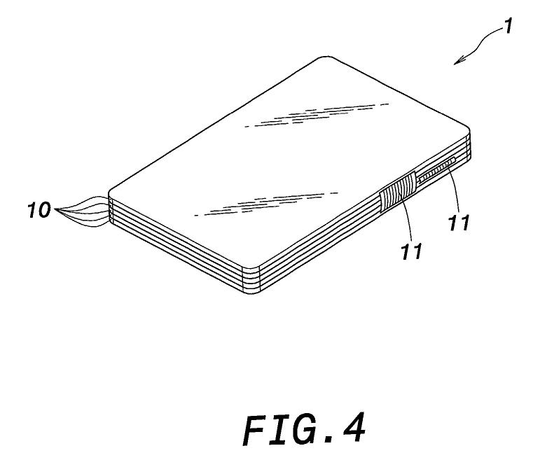

FIGS. 3 and 4 show the foldable keyboard of the present invention in expanding state and folding state, respectively. The present invention is intended to provide a foldable keyboard employing touch panel to enhance the portability and reduce assembling complexity thereof. The foldable keyboard of the present invention mainly comprises a keyboard body 1 and a plurality of keys 2.

The keyboard body 1 comprises at least two touch panels 10 arranged along a lateral direction and electrically connected by a plurality of FPC 11 (flexible printed circuits). The touch panels 10 can be operated to stack on each other due to the flexibility of the FPC 11. Therefore, the keyboard body 1 can be folded and expanded along the FPC 11.

Each of the touch panels 10 is segmented into a plurality of blocks 12 in similar manner to the segmentation of keys in conventional keyboard. Therefore, the keys 2 of the keyboard can be realized on those blocks 12. Moreover, a plurality of legends is formed on top surface or bottom surface of the keyboard body 1. For example, the legends may be formed by printing to facilitate typing operation for user. Alternatively, an auxiliary sounding unit (not shown) is connected to the keyboard body 1 and generates sound corresponding to typing of certain key 2 to facilitate typing operation for user. The arrangement of keys 2 and the auxiliary sounding unit are known in prior art and not described in detail here.

With reference now to FIGS. 3 and 4, a preferred embodiment of the present invention is demonstrated. The standard keyboard generally has a main typing region with area roughly equal to the area of five business cards (the area of main typing region in a standard keyboard is 275 mm×90 mm, and the area of a business card is 55 mm×90 mm). Therefore, the keyboard body 1 is composed of five touch panels 10 in this preferred embodiment, and each of the five touch panels 10 has an area same as that of a business card. Those touch panels 10 can be folded to have an area as that of a business card and the user can conveniently place the folded touch panels 10 in his pocket.

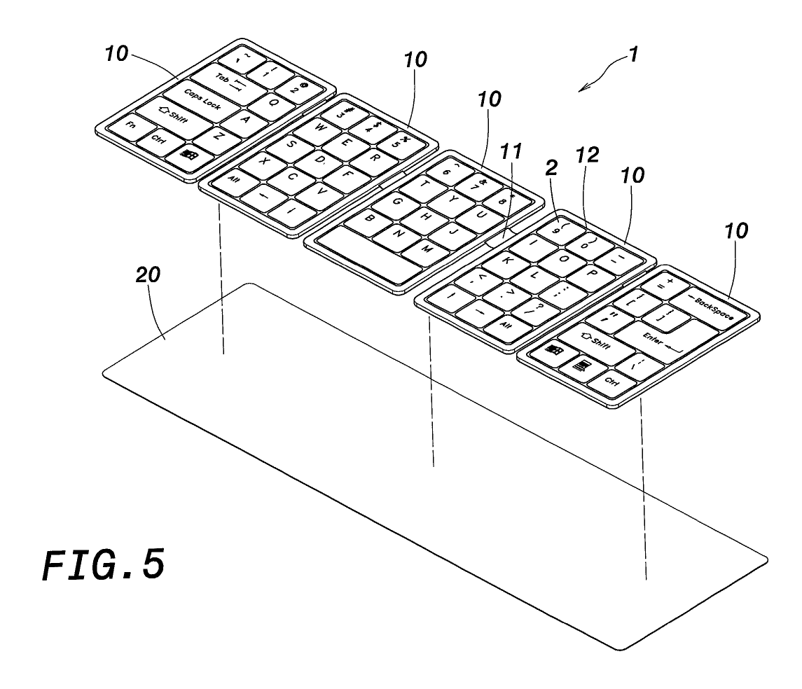

Moreover, as shown in FIG. 5, a protective layer 20 is provided for the keyboard body 1. The protective layer 20 can be formed by synthetic leather or by fuzz and has a size equal to that of the keyboard body 1 to cover the bottom of the keyboard body 1. The protective layer 20 provides protection function for the keyboard body 1 when the keyboard body 1 is placed on desktop or other surface. The protective layer 20 also has decorating effect for the keyboard body 1 and does not result much weight increment.

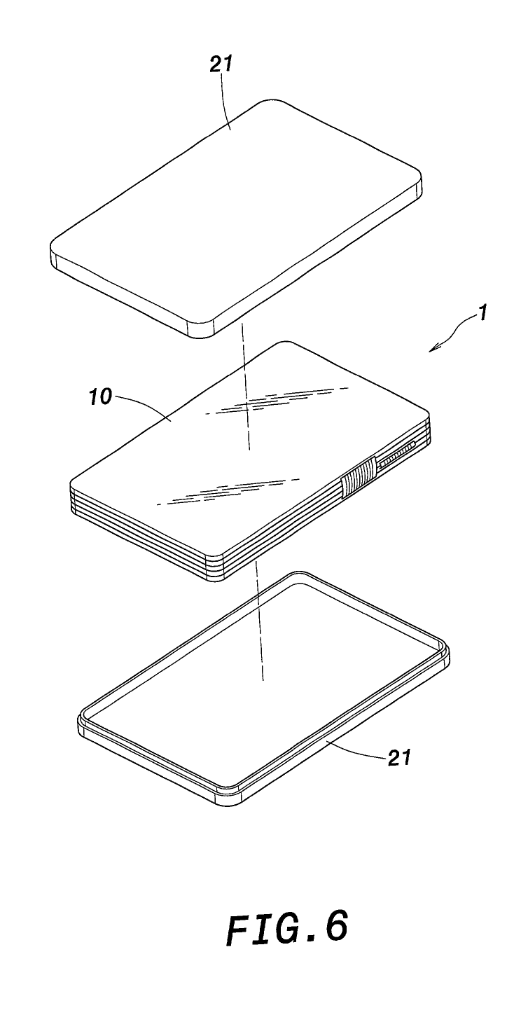

With reference now to FIG. 6, two outer cases 21 are provided on two outmost touch panels 10, respectively, when the when the foldable keyboard is folded. Therefore, the outer cases 21 can cover two outmost touch panels 10 of the foldable keyboard when the foldable keyboard is folded. The outer cases 21 can be made of Al-Mg alloy to provide protection function.

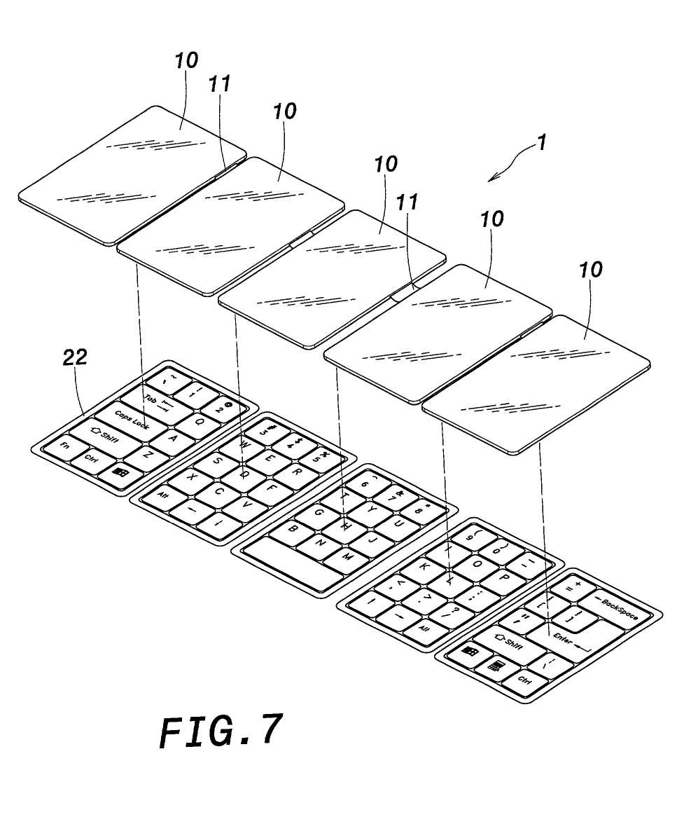

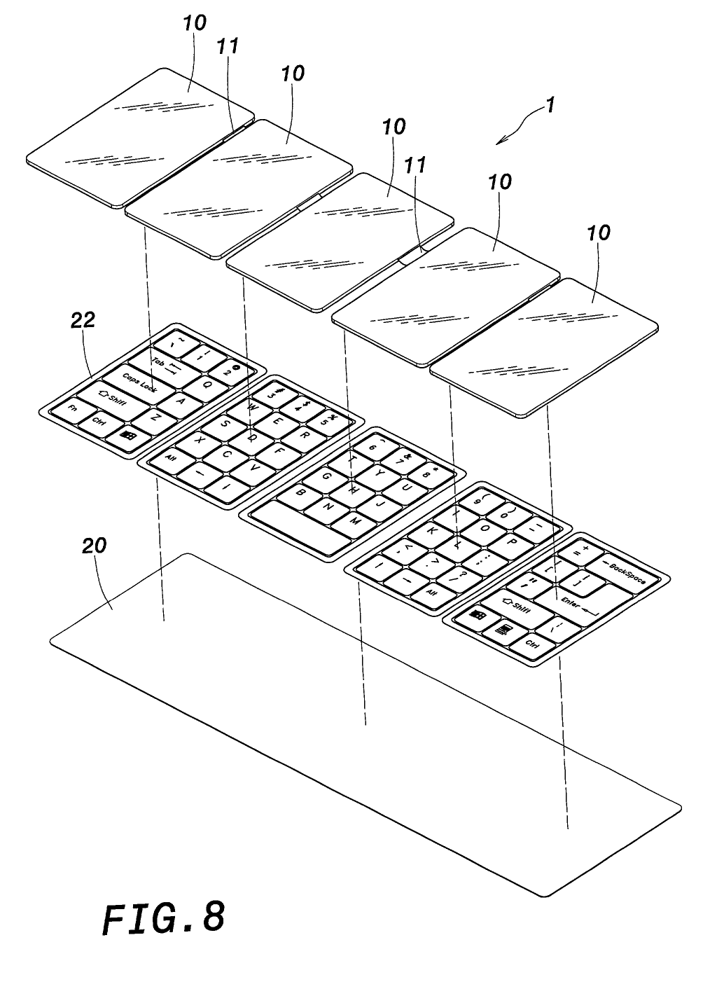

Moreover, with reference to FIGS. 7 and 8, the legends for the keys 2 of the foldable keyboard can be formed on a plurality of laminas 22, the number thereof depends on the number of the touch panels 10. The laminas 22 are arranged on bottom sides of corresponding touch panels 10 and can also be made of Al-Mg alloy. Moreover, the bottom surface of the laminas 22 can also be protected by protective layer 20.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A foldable keyboard comprising:
a keyboard body composed of at least two touch panels in serial connection and adjacent touch panels being connected by a flexible printed circuit such that the touch panels can be stacked each other and expanded;
a plurality of keys formed by segmenting a plurality of blocks on the touch panels.

2. The foldable keyboard as in claim 1, wherein the keyboard body is composed of five touch panels.

3. The foldable keyboard as in claim 2, wherein each of the touch panels has the same area as that of a business card.

4. The foldable keyboard as in claim 1, further comprising two outer cases provided for the foldable keyboard, wherein the outer cases cover the two outmost touch panels, respectively, when the foldable keyboard is folded.

5. The foldable keyboard as in claim 1, wherein the outer case is made of Al-Mg alloy.

6. The foldable keyboard as in claim 1, wherein a plurality of legends is formed on top surface or bottom surface of the keyboard body.

7. The foldable keyboard as in claim 1, further comprising a protective layer with shape corresponding to that of the keyboard body and covering the bottom of the keyboard body.

8. The foldable keyboard as in claim 7, wherein the protective layer is made of synthetic leather.

9. The foldable keyboard as in claim 1, further comprising at least two laminas, the laminas being provided with legends and having number corresponding to the number of the touch panels, the laminas being provided on bottom sides of corresponding touch panels.

10. The foldable keyboard as in claim 9, wherein each of the laminas is made of Al-Mg alloy.

11. The foldable keyboard as in claim 9, further comprising a protective layer with shape corresponding to that of the keyboard body and covering bottom surfaces of each lamina.

12. The foldable keyboard as in claim 11, wherein the protective layer is made of synthetic leather.
